(19) United States
(12) Patent Application Publication
(10) Pub. No.: US 2016/0320005 A1
(43) Pub. Date: Nov. 3, 2016

(54) EL SPOOL AND DOLLY

(71) Applicant: Roman Nosenkis, Toronto (CA)

(72) Inventor: Roman Nosenkis, Toronto (CA)

(21) Appl. No.: 15/140,466

(22) Filed: Apr. 27, 2016

Related U.S. Application Data
(60) Provisional application No. 62/154,096, filed on Apr. 28, 2015.

(51) Int. Cl. F21L 4/08; F21V 27/00; B65H 75/14; B65H 75/40; B65H 75/44

(52) U.S. Cl. CPC F21L 4/08; B65H 75/406; B65H 75/4492; B65H 75/14; F21V 27/005; B65H 2701/36; F21Y 2103/006

(57) ABSTRACT

A device includes a reel or spool; a dolly having the reel and having two handles for pushing the reel along the ground; an EL wire or tape which can be wound and unwound from the reel; and a battery pack having a battery and an inverter. The device can be used in several ways: by using the handles to push the reel along the ground to wind/unwind the EL wire; by laying the reel on its side and using a handle disposed on the reel for rotating the reel to wind/unwind the EL wire; and by supporting the reel above the ground atop its two handles to wind/unwind the EL wire. The battery pack is portable, and is connected to one end of the EL wire that passes through a side opening in the reel.

### CROSS REFERENCE TO RELATED APPLICATIONS

This application claims the priority of U.S. Provisional Application No. 62/154,096 filed on Apr. 28, 2015, inventor Roman Nosenkis, “EL SPOOL AND DOLLY.” The entire disclosure of this aforementioned provisional patent application is hereby incorporated in its entirety by reference thereto.

### STATEMENT REGARDING FEDERALLY SPONSORED RESEARCH OR DEVELOPMENT

Not applicable.

### FIELD OF THE INVENTION

The present invention relates to an EL spool and dolly, wherein the term EL refers to electroluminescent (“EL”) wire or tape; and to a self-contained portable power supply for EL wire carried on the EL spool.

### BACKGROUND OF THE INVENTION

It is a problem in the art to apply EL wire or tape, and to provide a source of self-contained power to the EL wire. This is of especial importance where the EL wire is to be applied over a large area and/or in a location where electrical outlets are not available.

Such EL wire typically includes a continuous base wire, plated with a metal modified layer. In one example, the metal wire is coated with a dielectric layer and the dielectric layer is coated with a luminous layer made of electroluminescent powder added with YAG to emit light. The luminous layer is coated with a transparent conductive layer which is connected to protective conductive wires, which are all enclosed by a fluoroplastics layer. The fluoroplastics layer can in turn be enclosed by a transparent and/or translucent colored plastic tubes. The plastic tubes may contain a fluorescent dye or paint, a scattering agent, and/or glass microballons. An alternating current is typically then applied between the metal layer and the outer protective conductive wire to cause illumination.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides a EL spool and dolly, together with a power supply having a battery power source. Here, the term EL refers to electroluminescent (“EL”) wire or tape.

More specifically, the device of the present invention includes a reel or spool; a dolly having the reel and having two handles for pushing the reel along the ground; an EL wire or tape which can be wound and unwound from the reel; and a battery pack having a battery and an inverter. The device can be used in several ways: by using the handles to push the reel along the ground to wind/unwind the EL wire; by laying the reel on its side and using a handle disposed on the reel for rotating the reel to wind/unwind the EL wire; and by supporting the reel above the ground atop its two handles to wind/unwind the EL wire. The battery pack is portable, and is connected to one end of the EL wire that passes through a side opening in the reel.

The battery pack of the present invention provides a self-contained portable power supply to supply power to the EL wire carried on the EL spool, and provides a rechargeable battery and a connection to an external source of power for recharging the rechargeable battery.

Other objects and advantages of the present invention will be more readily apparent from the following detailed description when read in conjunction with the accompanying drawings.

### BRIEF DESCRIPTION OF THE DRAWINGS

FIG. 1 is a perspective view of a device which includes a dolly and an EL reel, according to the present invention, wherein the dolly has two handles and the reel is directly rolled along the ground.

FIG. 2 is a perspective view of the device of FIG. 1, showing unwinding of the EL wire.

FIG. 3 is a perspective view of the reel of FIG. 1 laid on its side for unwinding of the EL wire, together with a battery pack and inverter.

FIG. 4 is a perspective view of the device of FIG. 1 supported by its handles, for winding of the EL wire.

FIG. 5 is a perspective view of the reel of FIG. 1, showing a handle, and opening in the reel's flange for the EL wire to come out, and an EL connector.

FIG. 6 is an exploded view of a power pack having a self-contained portable power supply to supply power to the EL wire of FIGS. 1-5, and having a rechargeable battery and a connection to an external source of power for recharging the rechargeable battery.

FIG. 7 is a schematic diagram showing connections of the components of FIG. 6.

### DETAILED DESCRIPTION OF THE INVENTION

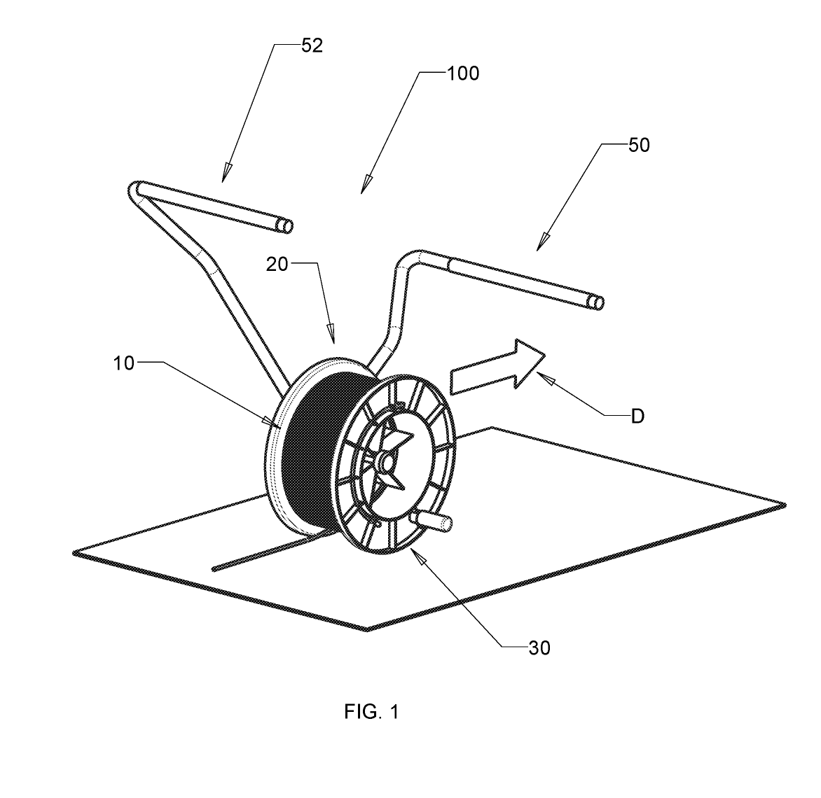

FIG. 1 is a perspective view of a device 100 which includes an EL reel 20, and a dolly having handles 50 and 52 and an axle for supporting the reel 20. The EL reel 20 carries EL wire 10. A handle 30 extends from the side of the reel 20. In FIG. 1, the EL wire 10 is wound/unwound from the reel 20 by rolling the reel 20 along the ground using either of the two handles 50 and 52 to push the reel 20 along the ground in a direction D.

As to terminology used herein, the portion 20 is described as a reel or spool 20. The EL wire 10 can be in any windable form, including in the form of wire or tape for example. All such variations are contemplated as being within the scope of the present invention.

In the dolly, details of the axle have been omitted from the drawings, other than one end which is connected to the reel 20 by blade-like members (unnumbered) connected to the reel 20 serving as spokes. The dolly can also include other components such as bearings and any other elements used in the reel arts, and all such variations are contemplated as being within the scope of the present invention.

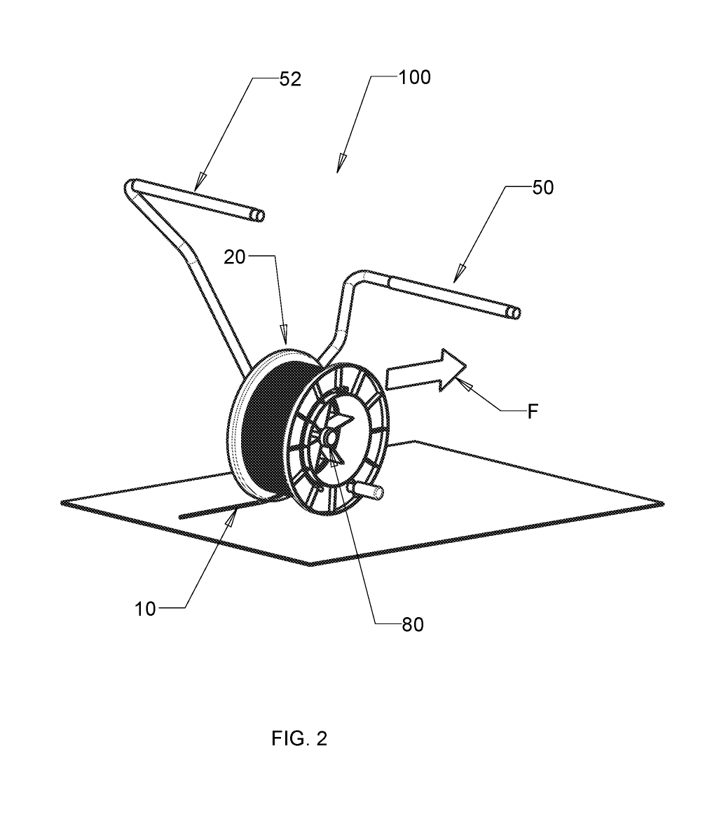

FIG. 2 is a perspective view of the device 100 of FIG. 1, showing unwinding of the EL wire 10. Here, the device 100 is pushed in a direction F along the ground to lay the EL wire 10 directly on grass. The dolly portion includes a quick disconnect nut 80 for removing the reel 20 from an axle (not shown) of the dolly 100.

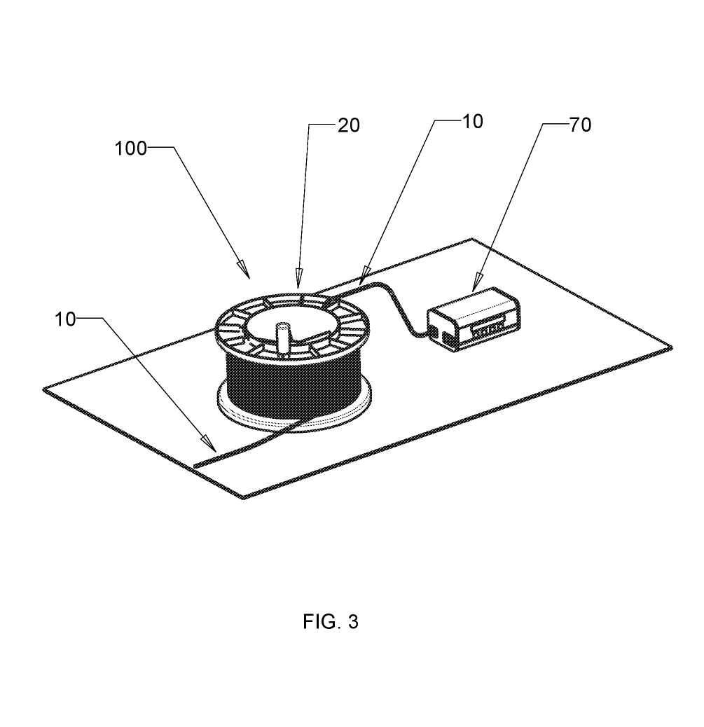

FIG. 3 is a perspective view of the reel 20 of FIG. 1 laid on its side for unwinding of the EL wire 10, together with a battery pack and inverter 70. The battery pack and inverter is electrically connectable/attachable to, and is detachable from, an end of the EL wire 20 that extends through a side of the reel 20. The connection between the battery pack and the EL wire can be made by a plug-in type of connection. The battery pack and inverter 70 are portable, and have an enclosure for all the electronics components, making the unit autonomous. These battery packs are modular, can be charged independently, and incorporate a battery, a charger, and an inverter.

In a preferred embodiment, the battery pack includes an electrical charging port or plug, so that portable electronics can be recharged or powered by the battery pack. The charging port or plug (not shown in the drawings) can include multiple connector types, for powering various types of devices such as cell phones, portable computers, mp3 players, portable lighting, and so on.

In the embodiment shown in FIG. 3, the battery pack is separate from the reel 20, and must therefore be carried separately.

In another embodiment of the invention, not shown in the drawings, the reel 20 carries the battery pack on the inside of the reel portion. The battery pack in this embodiment can be secured in any of these locations: (a) adjacent the axle; (b) between the axle and the underside of the outermost portion of the reel; and (c) adjacent an interior side of the rim (which is the underside of the outermost reel portion).

In one embodiment, the enclosure for the battery and inverter 70 is water proof and the enclosure completely sealed. The electronics components are adapted to be able to dissipate the heat outside by using passive cooling, without fans.

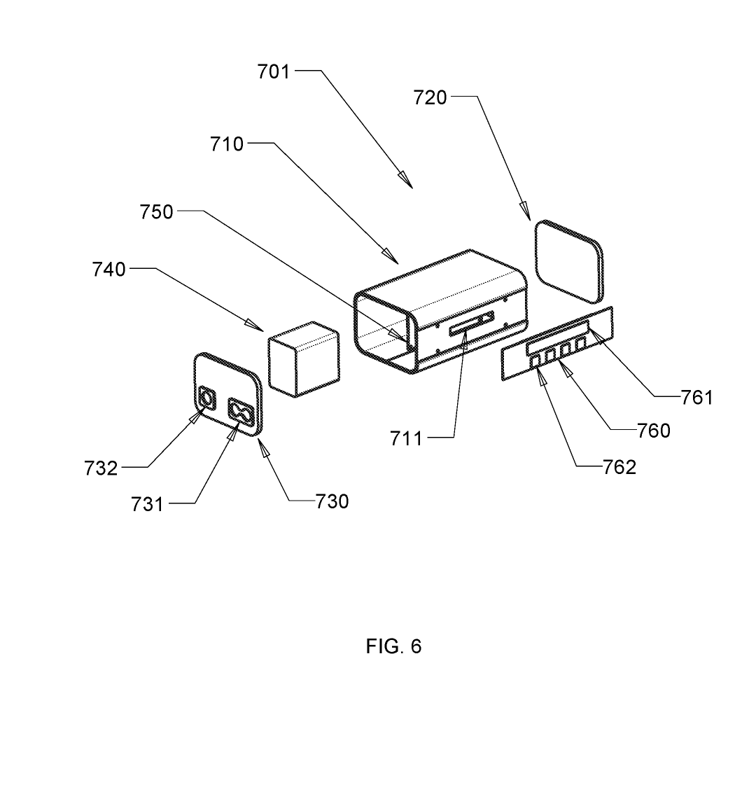

In the embodiment of FIG. 3, the battery pack and inverter 70 is shown lying on its side adjacent to the reel 20. In a further embodiment, the treel 20 includes an open interior or a deep recess for receiving the battery pack and inverter 70 therein. In this further embodiment, the reel 20 conveniently carries the battery pack and inverter 70 for ease of transport. The battery pack and inverter 70 is contained within the enclosure 701 shown in FIG. 6.

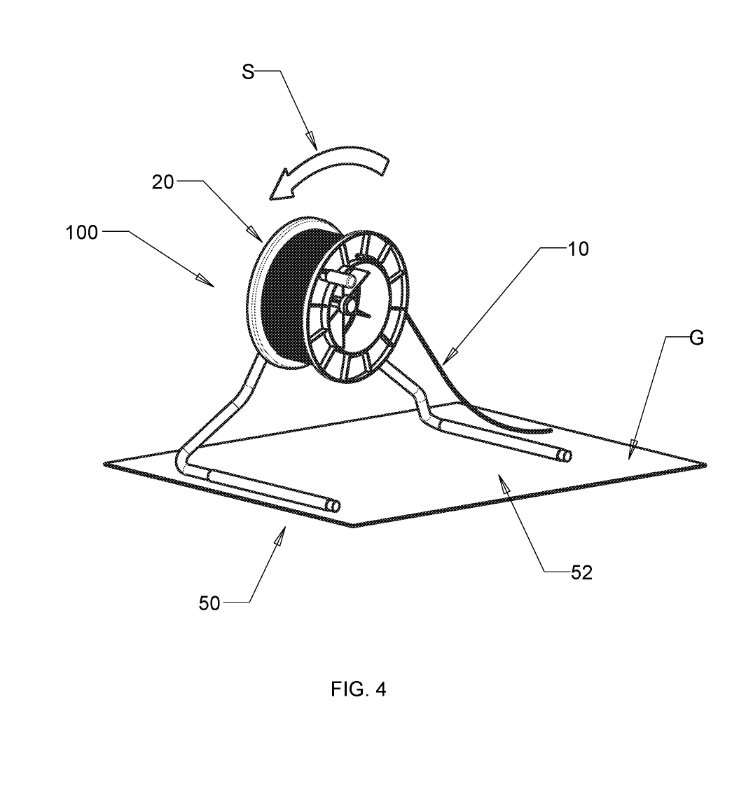

FIG. 4 is a perspective view of the device 100 of FIG. 1 supported by its handles 50 and 52, for winding of the EL wire 10 in a direction S. Here, the double handle dolly acts as a stable support during winding/unwinding of the EL wire 10.

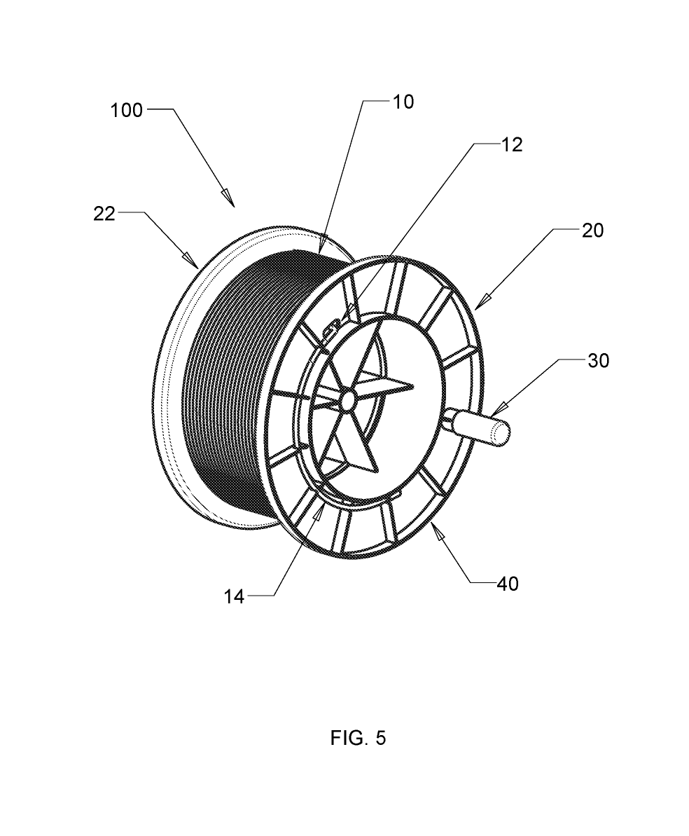

FIG. 5 is a perspective view of the reel 20 of FIG. 1, showing a handle 30 for manually rotating the reel 20, and also showing an opening 12 in the reel's flange for the EL wire 10 to come out, and an EL connector 40 at the end of the EL wire 10 which has come out of the opening 12 in the reel 20.

As shown in the drawings, the device 100 of the present invention includes a reel or spool 20; a dolly having the reel and having two handles for pushing the reel along the ground; an EL wire or tape which can be wound and unwound from the reel; and a battery pack having a battery and an inverter. The device can be used in several ways: by using the handles to push the reel along the ground to wind/unwind the EL wire; by laying the reel on its side and using a handle disposed on the reel for rotating the reel to wind/unwind the EL wire; and by supporting the reel above the ground atop its two handles to wind/unwind the EL wire. The battery pack is portable, and is connected to one end of the EL wire that passes through a side opening in the reel.

FIG. 6 is an exploded view of a power pack 701 having a self-contained portable power supply (the power pack corresponds to the battery and inverter 70 discussed hereinabove) to supply power to the EL wire 10 of FIGS. 1-5, and having a rechargeable battery 740, a charger and inverter 751, a control panel 760, and enclosure body 710, a left cover 730, a right cover 720, and a connection to an external source of power 732 for recharging the rechargeable battery 740. In this view, the control panel 760 is preferably a membrane type, having ON/OFF switches 761, and at least one LED indicator 762. The LED indicators 762 can be used for indicating the status of “power ON”, and also “STANDBY mode”, among other possible known types of control panel uses which are also contemplated as being within the scope of the present invention.

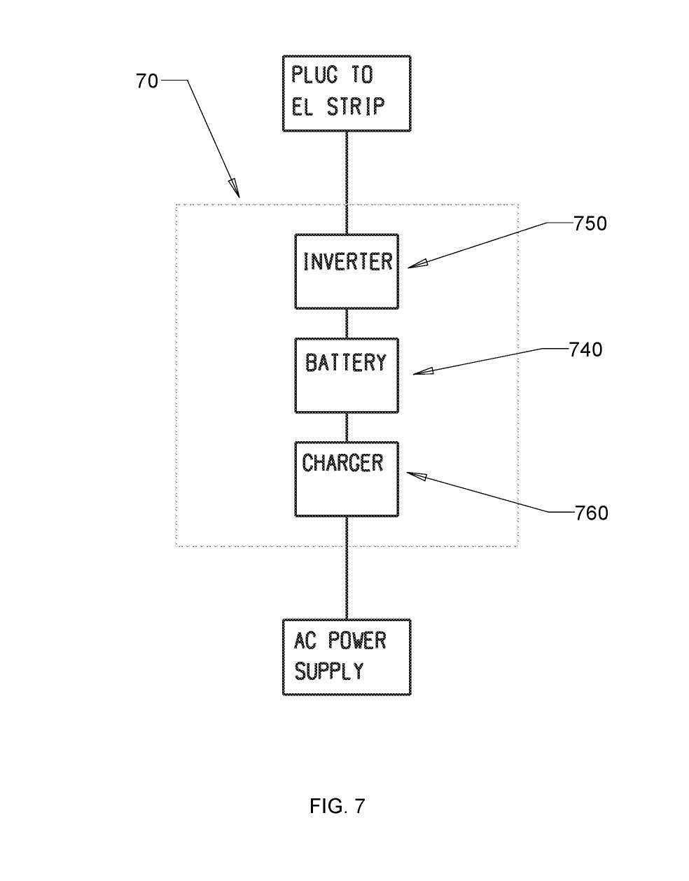

FIG. 7 is a schematic diagram showing connections of the components of FIG. 6. In one preferred embodiment of the present invention, the portable EL power device 70 includes the following components:

the inverter 750 represents two different inverters: One that is inverting AC to DC when charging a battery and the other is an inverter which feeds the power to the wire/tape with a certain amperage and frequency (depending on length, as discussed elsewhere herein). The inverters for supplying power to the EL wire/tape are known by any one having skill in the EL wire/tape power supply arts, and is not shown in detail herein.

Specifically, the battery charger and inverter 750 can convert when charging from 110V/220V AC to 12V DC, for its charging/maintaining function. Other types of chargers and inverters, which would be known to any one having skill in the charger and inverter arts, are also contemplated as being within the scope of the present invention, for example encompassing other

AC voltages and/or other DC voltages.

Lithium Battery cells 740 (4 or 8 are preferred; other numbers are also possible). Other types of battery can be used in the present invention, which would be known to any one having skill in the battery arts, are also contemplated as being within the scope of the present invention, such as capacitive batteries, other types of high performance batteries, and even older technology low performance batteries. The batteries preferably have sufficient power to light an EL strip that is 100 yards long, for a period of 12 hours. It is also contemplated as being within the scope of the present invention to have power sufficient for a lesser length of EL strip and for lesser periods of time, for example the batteries in another variation would be sufficiently large in capacity to power a 30 yard strip for 8 hours.

An EL Inverter 750. This could be any type of suitable inverter meeting the requirements for power capacity and usage for the use in supplying power to the EL strips as noted above, and being suitable for use in the enclosure shown, and such inverters would be known to any one having skill in the inverter and charger arts, and all such variations are contemplated as being within the scope of the present invention. In the preferred embodiment, the EL inverter 750 would have multiple outlets for powering more than one EL strip.

LED indicators 762 (Charging status, On/Off, battery low, etc,)

Connectors 731, 732 (power in, out)

A plastic enclosure body 710 (shell, cover, ends, etc.). The body 710 can also be composed of metal.

A control panel 760 (to control power on/off, switch between EL intensities, frequencies, pulsation. shut-off, etc).

A heatsink (not shown) can be added to dissipate the heat to outside the enclosure. In the preferred embodiment, the enclosure 70 can serve as a heat sink. The enclosure can be formed of metal or plastic, or any combination of same. The materials are not limited to metal or plastic, and other container/enclosure materials can be provided such as ceramics, or any other materials known to any one having skill in the battery and charger arts for electrical power supply use.

The device includes suitable sealing for protecting against humidity, water, dust, etc. This can be by provision of seals, gaskets, rubber sealing elements, and/or any other known sealing means for use with power supplies. (Example: possible IP 54 or IP65 protection.)

A handle is not present in the preferred embodiment, and it is contemplated that one or more handles can be provided in additional further embodiments of the present invention.

In the preferred embodiment, the battery pack 70 can supply power to EL wire/tape for lengths of 3 meters to 100 meters. In this preferred embodiment, the control panel 760 will include a switch (such as a membrane-type switch) for selection of length of the EL wire/tape, for providing appropriate levels of power and/or amperage and/or frequency thereto. That is, there will be a switch with which the operator can select the length of wire being connected to the battery box, from there different amperage as well as frequency will be supplied based on the length of wire selected. In one further embodiment, there are three such selections: 1-10 meters, 10-50 meters, and 50 -100 meters in length of EL tape/wire.

Known types of power supply systems for controlling power to an EL wire/tape are contemplated as being usable in the present invention. For example, U.S. Pat. No. 5,955,957 shows a schematic diagram of a circuit for controlling an EL wire/tape, and the entire disclosure of this patent is hereby expressly incorporated herein by reference thereto.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A device for applying EL wire across and surface and for supplying power to the EL wire, comprising:
a reel adapted for winding and unwinding of EL wire;
a dolly for supporting said reel, said dolly including two handles for pushing said reel along a surface; said handles being adapted to have a pushing position wherein said reel can be rolled across a surface and to have a rest position wherein said handles rest on said surface while holding said reel above said surface so that said reel can rotate freely;
an EL wire which can be wound and unwound from the reel; and
a power pack having a rechargeable battery and an inverter for providing power to said battery when connected to an external A/C power source, whereby said EL wire can be wound and unwound by using said handles to push said reel across said surface, and whereby said EL wire can be wound and unwound from said reel by resting said reel on its side and rotating said reel to wind and unwind said EL wire, and whereby said reel can be supported by said handles above said surface atop said two handles to wind and unwind said EL wire.

2. The device according to claim 1, wherein said power pack is portable, and said reel has a side opening; and where said power pack is connected to one end of said EL wire which passes through said side opening in said reel.

3. The device according to claim 1, wherein said power pack includes at least four rechargeable lithium cell batteries.

4. The device according to claim 1, wherein said EL wire is in the form of an EL tape.

5. A portable device for supplying power to an EL wire, comprising:
a housing;
a battery;
at least one connector mounted on said housing, for connecting an external power source to said battery;
at least one outlet mounted on said housing, for supplying power from said battery to said EL wire;
and a charger and inverter for providing power to said battery when connected to an external A/C power source.

6. The device according to claim 5, wherein said battery is composed of at least four lithium battery cells.

7. The device according to claim 5, wherein said EL wire is in the form of an EL tape.

8. The device according to claim 5, wherein said housing includes four side walls and two end walls bounding an enclosed volume, and wherein said housing is sealed to prevent entry of moisture into said enclosed volume.
